(19) United States
(12) Patent Application Publication
(10) Pub. No.: US 2024/0228366 A9
(43) Pub. Date: Jul. 11, 2024

(54) GLASS CERAMIC WITH QUARTZ SOLID SOLUTION PHASES

(71) Applicant: Ivoclar Vivadent AG, Schaan (LI)

(72) Inventors: Markus RAMPF, Seewis-Dorf (CH); Marc DITTMER, Feldkirch (AT); Christian RITZBERGER, Grabs (CH)

(21) Appl. No.: 18/547,552

(22) PCT Filed: Feb. 17, 2022
(86) PCT No.: PCT/EP2022/054006

§ 371 Date: Aug. 23, 2023

(30) Foreign Application Priority Data
Feb. 24, 2021 (EP) 21159117.7

(51) Int. Cl. C03C 10/00; A61C 13/00; C03B 32/02; C03C 4/00

(52) U.S. Cl. CPC C03C 10/0009; A61C 13/0003; C03B 32/02; C03C 4/0021; C03C 10/0054; C03C 2204/00

(57) ABSTRACT

Quartz solid solution glass ceramics and precursors thereof are described. which are characterized by very good mechanical and optical properties and can be used in particular as restorative materials in dentistry.

The invention relates to glass ceramics with quartz solid solution phases, which are particularly suitable for use in dentistry and preferably for the production of dental restorations, and to precursors for the production of these glass ceramics.

Glass ceramics with quartz solid solution phase are basically known from the prior art.

DE 25 07 131 A1 describes special magnesium aluminosilicate glass ceramics containing 45 to 65 wt.-% SiO₂, 20 to 35 wt.-% Al₂O₃ and 9 to 15 wt.-% MgO. Bodies made from the glass ceramics have a heterogeneous structure in that the crystal structure of the surface layer differs from that of the interior of the bodies. The surface compressive stress generated in this way has a significant influence on the mechanical properties, so that machining of the surface layer would result in a deterioration of the mechanical properties. High quartz solid solutions were detected in the surface layer and low quartz solid solutions in the interior of the bodies.

JP 2000/063144 A discloses magnesium aluminosilicate glasses for the preparation of substrates for storage media containing 30 to 60 mol % SiO₂ and large amounts of B₂O₃.

GB 2 172 282 A describes magnesium aluminosilicate glass ceramics containing 30 to 55 wt.-% SiO₂ and 10 to 40 wt.-% Al₂O₃. The glass ceramics are intended for microelectronic applications and in particular as a coating for substrates such as aluminum, and in addition to high strength they have a suitable dielectric constant in the range from 7 to 10 and a high electrical resistance.

WO 2012/143137 A1 describes glass ceramic bodies containing at least 10.1 wt.-% Al₂O₃ and having different crystal phases in different areas.

WO 2015/155038 A1 describes glass ceramics with quartz solid solution phase for use in dentistry. Glass ceramics containing several quartz solid solution phases are not described.

In the article by M. Dittmer and C. Russel in J. Biomed. Mater. Res. Part B: 100B: 463-470 (2012), glass ceramics with high quartz or low quartz solid solution phase as the main crystalline phase are described, comprising a maximum of 55.1 wt.-% SiO₂ and at least 25.9 wt.-% Al₂O₃.

All in all, the strengths achieved with these known glass ceramics and also their translucency are not completely satisfactory for an application as a dental material.

The invention is therefore based on the problem of providing a glass ceramic that has a combination of high strength and good translucency. The glass ceramic should also have a coefficient of thermal expansion that can be adjusted over a wide range. The glass ceramic should also be easy to process into dental restorations and thus be suitable in an excellent manner as a restorative dental material.

This problem is solved by the glass ceramic with two different quartz solid solution phases according to claims 1 to 18 and 21. Also subject of the invention are the starting glass according to claims 19 to 21, the processes according to claims 22 and 25, and the use according to claims 23 and 24.

The glass ceramic according to the invention is characterized in that it comprises the following components

| Component | Wt.-% |
|---|---|
| SiO₂ | 68.0 to 81.0 |
| Li₂O | 6.0 to 14.0 |
| Al₂O₃ | 1.0 to 8.0 |

and comprises at least two different quartz solid solution phases.

This glass-ceramic, hereinafter also referred to as “glass-ceramic with multiple quartz solid solution phases”, surprisingly exhibits an advantageous combination of mechanical and optical properties desirable for a restorative dental material. The glass ceramic has high strength and yet it can be easily given the shape of a dental restoration by pressing or machining. Furthermore, it was not expected that very good optical properties could nevertheless be achieved by providing multiple quartz solid solution phases. This is because many secondary crystal phases have a negative effect on the optical properties of glass ceramics. For example, they can reduce translucency and they can also impair the possibility to impart color to the glass ceramic, which can lead to considerable difficulties in imitating the color of the natural tooth material to be replaced.

Furthermore, it has been shown that the thermal expansion coefficient of the glass ceramics according to the invention can be varied over a wide range by the type and amount of quartz solid solution phases formed. Finally, it was also found that the glass ceramics according to the invention can be densely sintered at higher temperatures than lithium silicate-quartz glass-ceramics without losing their shape.

The term “quartz solid solution phase” refers to a crystal phase of SiO₂ in which foreign atoms are incorporated into the lattice of the SiO₂ either in interstitial sites or in lattice sites. These foreign atoms can be in particular Al as well as Li, Mg and/or Zn. Al can preferably be present in a molar concentration corresponding to the sum of the molar concentration of Li, double the molar concentration of Mg and double the molar concentration of Zn.

The quartz solid solution phases can be both stoichiometric and non-stoichiometric quartz solid solution phases. By stoichiometric quartz solid solution phases are meant those crystal phases in which the number of silicon atoms and the number of one of the foreign atoms are in the ratio x:y, where x and y are integers in the range from 1 to 8 and in particular in the range from 1 to 5. In a preferred embodiment, the glass ceramic comprises at least one and preferably at least two non-stoichiometric quartz solid solution phases.

At least one of the quartz solid solution phases may be a stoichiometric or non-stoichiometric aluminosilicate crystal phase. In a preferred embodiment, the glass ceramic comprises at least one and preferably at least two stoichiometric or non-stoichiometric aluminosilicate crystal phases. In a particularly preferred embodiment, the glass ceramic comprises at least one and preferably at least two non-stoichiometric aluminosilicate crystal phases. In this context, stoichiometric aluminosilicate crystal phases are understood to be those crystal phases in which the number of silicon atoms and the number of aluminum atoms are in the ratio x:y, where x and y are integers in the range from 1 to 8 and in particular in the range from 1 to 5. Examples of stoichiometric aluminosilicate crystal phases are eucryptite (LiAlSiO₄), spodumene (LiAlSi₂O₆), petalite (LiAlSi₄O₁₀) and cordierite (Mg₂Al₄Si₅O₁₈).

The glass ceramic according to the invention preferably comprises at least two different quartz solid solution phases whose reflection peaks with the highest intensity in X-ray powder diffraction with Cu_{Kα} radiation are each in the range of 25 to 26.7° 2θ, preferably in the range of 25.5 to 26.6° 2θ and particularly preferably in the range of 25.8 to 26.5° 2θ.

Furthermore, a glass ceramic is preferred which comprises two different quartz solid solution phases whose reflection peaks with the highest intensity in X-ray powder diffraction with Cu_{Kα} radiation have a spacing of at least 0.2° 2θ, preferably at least 0.3° 2θ and particularly preferably at least 0.4° 2θ and in particular a spacing of 0.2 to 0.7° 2θ, preferably 0.3 to 0.6° 2θ and particularly preferably 0.4 to 0.5° 2θ.

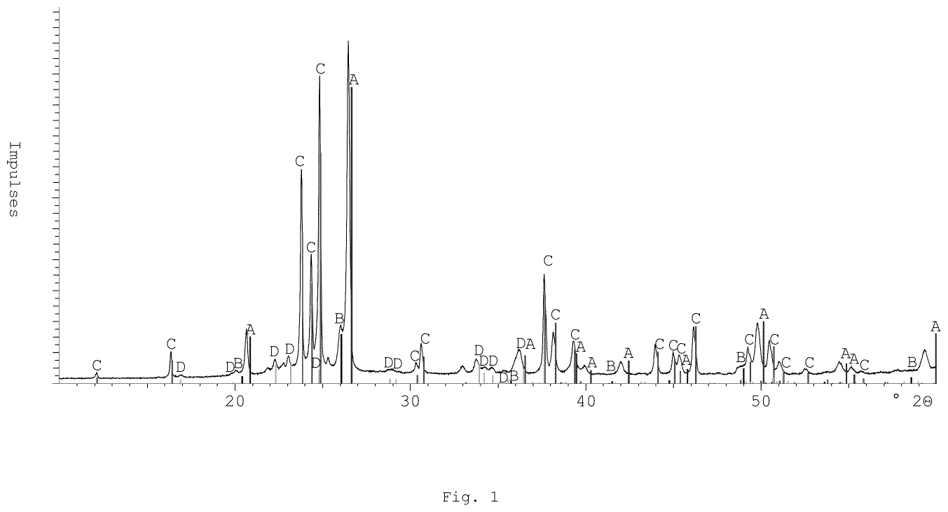

The quartz solid solution phases of the glass ceramic according to the invention can be detected in particular by X-ray powder diffraction using Cu_{Kα} radiation. The quartz solid solution phases show characteristic peak patterns, each of which is derived from the peak pattern of low quartz but is shifted to different 2θ values. This is illustrated in FIG. 1 by the X-ray powder diffraction pattern of the glass ceramic obtained in Example 19. Therein, several peak patterns contained in the PDF-4+ 2020 (International Centre for Diffraction Data) database are reproduced below the X-ray powder diffraction pattern. The peak pattern of low quartz (α-SiO₂) is marked with the letter “A” and shows the peak with the highest intensity between 26.6 and 26.7° 2θ. In the X-ray powder diffraction diagram, two quartz solid solution phases can be seen whose peak patterns are shifted towards smaller 2θ values compared to the peak pattern of low quartz and whose peaks with the highest intensity are located at 26.5° 2θ and at 26.0° 2θ, respectively.

The glass ceramic with multiple quartz solid solution phases according to the invention comprises in particular 70.0 to 79.0 and particularly preferably 73.0 to 76.0 wt.-% SiO₂.

It is further preferred that the glass ceramic according to the invention comprises 7.5 to 13.0 and particularly preferably 9.0 to 12.0 wt.-% Li₂O. It is assumed that Li₂O lowers the viscosity of the glass matrix and thus promotes crystallization of the desired phases.

In a preferred embodiment, the glass ceramic according to the invention comprises 2.0 to 6.5 and particularly preferably 3.0 to 6.0 wt.-% Al₂O₃.

In another preferred embodiment, the glass ceramic comprises 1.0 to 7.0, preferably 2.5 to 5.0, and particularly preferably 3.0 to 4.4 wt.-% P₂O₅. It is assumed that the P₂O₅ acts as nucleating agent.

It is also preferred that the glass-ceramic comprises 1.0 to 8.0, preferably 1.0 to 5.5, and particularly preferably 1.5 to 2.5 wt.-% oxide of monovalent elements Me^{I}₂O selected from the group of K₂O, Na₂O, Rb₂O, CS₂O, and mixtures thereof.

Particularly preferably, the glass comprises at least one and in particular all of the following oxides of monovalent elements Me^{I}₂O in the amounts indicated:

| Component | Wt.-% |
|---|---|
| K₂O | 0 to 5.0 |
| Na₂O | 0 to 2.0 |
| Rb₂O | 0 to 8.0 |
| Cs₂O | 0 to 7.0. |

In a particularly preferred embodiment, the glass ceramic according to the invention comprises 0 to 5.0, preferably 1.0 to 3.5 and particularly preferably 1.5 to 2.5 wt.-% K₂O.

Furthermore, it is preferred that the glass ceramic comprises 0 to 9.0, preferably 2.0 to 8.0, and particularly preferably 3.0 to 7.0 wt.-% oxide of divalent elements Mello selected from the group of Cao, MgO, SrO, ZnO and mixtures thereof.

In another preferred embodiment, the glass ceramic comprises less than 2.0 wt.-% of BaO. In particular, the glass ceramic is substantially free of BaO.

Preferably, the glass ceramic comprises at least one and in particular all of the following oxides of divalent elements Me^{II}O in the amounts indicated:

| Component | Wt.-% |
|---|---|
| CaO | 0 to 3.0 |
| MgO | 0 to 6.0 |
| SrO | 0 to 5.0 |
| ZnO | 0 to 3.0 |

In a particularly preferred embodiment, the glass ceramic according to the invention comprises 0 to 6.0, in particular 0.1 to 6.0, preferably 1.0 to 5.5, more preferably 2.0 to 5.0, especially preferably 2.5 to 4.5 and most preferably 3.0 to 4.0 wt.-% MgO.

Further, a glass ceramic is preferred which comprises 0 to 5.0, preferably 1.0 to 4.0, and particularly preferably 2.0 to 3.0 wt.-% oxide of trivalent elements Me^{III}₂O₃ selected from the group of B₂O₃, Y₂O₃, La₂O₃, Ga₂O₃, In₂O₃, and mixtures thereof.

Particularly preferably, the glass ceramic comprises at least one and in particular all of the following oxides of trivalent elements Me^{III}₂O₃ in the amounts indicated:

| Component | Wt.-% |
|---|---|
| B₂O₃ | 0 to 4.0 |
| Y₂O₃ | 0 to 5.0 |
| La₂O₃ | 0 to 5.0 |
| Ga₂O₃ | 0 to 3.0 |
| In₂O₃ | 0 to 5.0 |

Furthermore, a glass ceramic is preferred which comprises 0 to 10.0 and particularly preferably 0 to 8.0 w.-t % oxide of tetravalent elements Me^{IV}O₂ selected from the group of ZrO₂, TiO₂, SnO₂, CeO₂, GeO₂ and mixtures thereof.

Particularly preferably, the glass ceramic comprises at least one and in particular all of the following oxides of tetravalent elements Me^{IV}O₂ in the amounts indicated:

| Component | Wt.-% |
|---|---|
| ZrO₂ | 0 to 3.0 |
| TiO₂ | 0 to 4.0 |
| SnO₂ | 0 to 3.0 |
| GeO₂ | 0 to 9.0, in particular 0 to 8.0 |
| CeO₂ | 0 to 4.0. |

In another embodiment, the glass ceramic comprises 0 to 8.0, preferably 0 to 6.0 wt.-% oxide of pentavalent elements Me^{V}₂O₅ selected from the group of V₂O₅, Ta₂O₅, Nb₂O₅ and mixtures thereof.

Particularly preferably, the glass ceramic comprises at least one and in particular all of the following oxides of pentavalent elements Me^{V}₂O₅ in the amounts indicated:

| Component | Wt.-% |
|---|---|
| V₂O₅ | 0 to 2.0 |
| Ta₂O₅ | 0 to 5.0 |
| Nb₂O₅ | 0 to 5.0 |

In another embodiment, the glass ceramic comprises 0 to 5.0, preferably 0 to 4.0 wt.-% oxide of hexavalent elements Me^{VI}O₃ selected from the group consisting of WO₃, MoO₃ and mixtures thereof.

Particularly preferably, the glass ceramic comprises at least one and in particular all of the following oxides Me^{VI}O₃ in the amounts indicated:

| Component | Wt.-% |
|---|---|
| WO₃ | 0 to 3.0 |
| MoO₃ | 0 to 3.0 |

In a further embodiment, the glass ceramic according to the invention comprises 0 to 1.0 and in particular 0 to 0.5 wt.-% fluorine.

Particularly preferred is a glass ceramic which comprises at least one and preferably all of the following components in the amounts indicated:

| Component | Wt.-% |
|---|---|
| SiO₂ | 68.0 to 81.0 |
| Li₂O | 6.0 to 14.0 |
| Al₂O₃ | 1.0 to 8.0 |
| P₂O₅ | 1.0 to 7.0 |
| Me^{I}₂O | 1.0 to 8.0 |
| Me^{II}O | 0 to 9.0 |
| Me^{III}₂O₃ | 1.0 to 8.0 |
| Me^{IV}O₂ | 0 to 10.0 |
| Me^{VI}₂O₅ | 0 to 8.0 |
| Me^{VI}O₃ | 0 to 5.0 |
| Fluorine | 0 to 1.0, |

wherein Me^{I}₂O, Me^{II}O, Me^{III}₂O₃, Me^{IV}O₂, Me^{V}₂O₅ and Me^{VI}O₃ are as defined above.

In another particularly preferred embodiment, the glass ceramic comprises at least one and preferably all of the following components in the amounts indicated:

| Component | wt.-% |
|---|---|
| SiO₂ | 68.0 to 81.0 |
| Li₂O | 8.0 to 14.0 |
| Al₂O₃ | 1.0 to 8.0 |
| P₂O₅ | 1.0 to 7.0 |
| K₂O | 0 to 5.0 |
| Na₂O | 0 to 2.0 |
| Rb₂O | 0 to 8.0 |
| Cs₂O | 0 to 7.0 |
| CaO | 0 to 3.0 |
| MgO | 0 to 6.0 |
| SrO | 0 to 5.0 |
| ZnO | 0 to 3.0 |
| B₂O₃ | 0 to 4.0 |
| Y₂O₃ | 0 to 5.0 |
| La₂O₃ | 0 to 5.0 |
| Ga₂O₃ | 0 to 3.0 |
| In₂O₃ | 0 to 5.0 |
| ZrO₂ | 0 to 3.0 |
| TiO₂ | 0 to 4.0 |
| SnO₂ | 0 to 3.0 |
| GeO₂ | 0 to 9.0, in particular 0 to 8.0 |
| CeO₂ | 0 to 4.0 |
| V₂O₅ | 0 to 2.0 |
| Ta₂O₅ | 0 to 5.0 |
| Nb₂O₅ | 0 to 5.0 |
| WO₃ | 0 to 3.0 |
| MoO₃ | 0 to 3.0 |
| Fluorine | 0 to 1.0. |

Some of the above components may serve as colorants and/or fluorescent agents. The glass ceramic according to the invention may furthermore contain further colorants and/or fluorescent agents. These may be selected, for example, from Bi₂O₃ or Bi₂O₅ and, in particular, from further inorganic pigments and/or oxides of d and f elements, such as the oxides of Mn, Fe, Co, Pr, Nd, Tb, Er, Dy, Eu and Yb. By means of these colorants and fluorescent agents, it is possible to easily color the glass ceramic to imitate the desired optical properties, especially of natural dental material. It is surprising that this is easily possible despite the presence of several quartz solid solution phases.

In a preferred embodiment of the glass ceramic, the molar ratio of SiO₂ to Li₂O is in the range of 2.2 to 6.0, preferably 2.8 to 5.0, and particularly preferably 3.0 to 4.0. It is surprising that within these broad ranges the preparation of the glass ceramic of the invention with multiple quartz solid solution phases is possible.

It is further preferred that the glass ceramic according to the invention contains lithium disilicate or lithium metasilicate as further crystal phases and in particular as main crystal phase. It is particularly preferred that the glass ceramic according to the invention contains lithium disilicate as further crystal phase and in particular as main crystal phase.

The term “main crystal phase” refers to the crystal phase which has the highest weight fraction of all crystal phases present in the glass ceramic. The amounts of the crystal phases are determined in particular by the Rietveld method. A suitable procedure for the quantitative analysis of the crystal phases by means of the Rietveld method is described, for example, in the dissertation by M. Dittmer “Gläser und Glaskeramiken im System MgOAl₂O₃—SiO₂ mit ZrO₂ als Keimbildner”, University of Jena 2011.

It is preferred that the glass ceramic according to the invention comprises at least 20 wt.-%, preferably 25 to 55 wt.-% and particularly preferably 30 to 55 wt.-% lithium disilicate crystals.

It is further preferred that the glass ceramic according to the invention comprises 0.2 to 28 wt.-% and preferably 0.2 to 25 wt.-% quartz solid solutions.

The glass ceramic with multiple quartz solid solution phases according to the invention is characterized by particularly good mechanical properties and optical properties, and it can be formed by heat treatment of a corresponding starting glass or a corresponding starting glass with nuclei. These materials can therefore serve as precursors for the glass ceramic with multiple quartz solid solution phases according to the invention.

The type and in particular the amount of crystal phases formed can be controlled by the composition of the starting glass as well as the heat treatment applied to produce the glass ceramic from the starting glass. The examples illustrate this by varying the composition of the starting glass and the heat treatment applied.

The glass ceramic has a high biaxial fracture strength of preferably at least 200 MPa and particularly preferably 250 to 460 MPa. The biaxial fracture strength was determined in accordance with ISO 6872 (2008) (piston-on-three-balls test).

The glass-ceramic according to the invention has a coefficient of thermal expansion CTE (measured in the range from 100 to 500° C.) of in particular 3.0 to 14.0 10⁻⁶·K⁻¹, preferably 5.0 to 14.0·10⁻⁶ K⁻¹ and particularly preferably 7.0 to 14.0·10⁻⁶ K⁻¹. The CTE is determined according to ISO 6872 (2008). Adjustment of the coefficient of thermal expansion to a desired value is effected in particular by the type and amount of crystal phases present in the glass ceramic and by the chemical composition of the glass ceramic.

The translucency of the glass ceramic was determined in terms of the contrast value (CR value) according to British Standard BS 5612, and this contrast value was preferably 40 to 92.

The particular combination of properties present in the glass ceramic according to the invention even allows it to be used as dental material and in particular as material for the preparation of dental restorations.

The invention also relates to precursors of corresponding composition from which the glass ceramics of the invention with multiple quartz solid solution phases can be produced by heat treatment. These precursors are a correspondingly composed starting glass and a correspondingly composed starting glass with nuclei. The term “corresponding composition” means that these precursors contain the same components in the same amounts as the glass ceramic, the components being calculated as oxides as is usual for glasses and glass ceramics, with the exception of fluorine.

The invention therefore also relates to a starting glass containing the components of the glass ceramic with multiple quartz solid solution phases according to the invention.

Thus, the starting glass according to the invention contains in particular suitable amounts of SiO₂, Li₂O and Al₂O₃, which are required to form the glass ceramic according to the invention with multiple quartz solid solution phases. Further, the starting glass may also contain other components as indicated above for the glass ceramic with multiple quartz solid solution phases according to the invention. All such embodiments are preferred for the components of the starting glass that are also indicated as preferred for the components of the glass ceramic with multiple quartz solid solution phases according to the invention.

Particularly preferably, the starting glass is in the form of a powder, a granulate or a powder compact pressed from a powder or granulate. In contrast to a glass monolith, such as is obtainable by pouring a glass melt into a mold, the starting glass in the above-mentioned forms has a large inner surface at which the subsequent crystallization of several quartz solid solution phases can take place.

The invention also relates to such a starting glass which contains nuclei for the crystallization of multiple quartz solid solution phases. Preferably, the starting glass further contains nuclei for the crystallization of lithium disilicate or lithium metasilicate.

In particular, the starting glass is produced by melting a mixture of suitable starting materials, such as carbonates and oxides, at temperatures of in particular about 1500 to 1700° ° C. for 0.5 to 4 h. To achieve a particularly high homogeneity, the obtained glass melt can be poured into water to produce a glass frit, and the obtained frit is then melted again.

The melt can then be cast in moulds, such as steel or graphite moulds, to produce blanks of the starting glass, so-called solid glass blanks or monolithic blanks. Usually these monolithic blanks are then stressed relieved, for example by maintaining them for 5 to 60 min at 800 to 1200° ° C., and then slowly cooled to room temperature.

In a preferred embodiment the melt is poured into water to produce a frit. This glass frit can be processed into a powder or granules by grinding. Preferably, the powder or granules obtained in this way can be pressed into a blank, a so-called powder compact, if necessary after the addition of further components, such as coloring and fluorescent agents.

By heat treatment of the starting glass, the further precursor starting glass with nuclei can first be produced. By heat treatment of this further precursor, the glass ceramic according to the invention with several quartz solid solution phases can then be produced. Alternatively, the glass ceramic according to the invention with multiple quartz solid solution phases can be formed by heat treatment of the starting glass.

It is preferred to subject the starting glass to a heat treatment at a temperature of 400 to 600° C., in particular 450 to 550° ° C., for a duration of preferably 5 to 120 min, in particular 10 to 60 min, to produce the starting glass with nuclei for the crystallization of multiple quartz solid solution phases.

It is further preferred to subject the starting glass or the starting glass with nuclei to a heat treatment at a temperature of 800 to 1000° C., preferably 850 to 950° C., for a duration of in particular 1 to 120 min, preferably 5 to 120 min, particularly preferably 10 to 60 min, to produce the glass ceramic with multiple quartz solid solution phases.

The invention therefore also relates to a process for producing the glass ceramic according to the invention with multiple quartz solid solution phases, in which the starting glass or the starting glass with nuclei, in particular in particulate form, preferably in the form of a powder and particularly preferably in the form of a powder compact, is subjected to at least one heat treatment in the range from 800 to 1000° C., preferably 850 to 950° C., for a duration of in particular 1 to 120 min, preferably 5 to 120 min, and particularly preferably 10 to 60 min, and in particular is sintered.

The at least one heat treatment carried out in the process according to the invention can also be carried out in the course of hot pressing or sintering of the starting glass according to the invention or of the starting glass according to the invention with nuclei.

The glass ceramics according to the invention and the glasses according to the invention are present in particular as powders, granulates or blanks of any shape and size, e.g. monolithic blanks, such as platelets, cuboids or cylinders, or powder compacts. In these forms, they can be easily further processed, e.g. into dental restorations. However, they can also be in the form of dental restorations, such as inlays, onlays, crowns, veneers, facets or abutments.

Dental restorations, such as bridges, inlays, onlays, crowns, veneers, facets or abutments, can be prepared from the glass ceramics according to the invention and the glasses according to the invention. The invention therefore also relates to their use in producing dental restorations. It is preferred that the glass ceramic or glass is given the shape of the desired dental restoration by pressing or machining.

The pressing is usually carried out under elevated pressure and temperature. It is preferred that the pressing is carried out at a temperature of 700 to 1200° C. It is further preferred that the pressing is carried out at a pressure of 2 to 10 bar. During pressing, the desired change in shape is achieved by viscous flow of the material used. The starting glass according to the invention, the starting glass according to the invention with nuclei and the glass ceramic according to the invention with multiple quartz solid solution phases can be used for the pressing. In particular, the glasses and glass ceramics according to the invention can be used in the form of blanks of any shape and size, e.g. powder compacts, for example in unsintered, partially sintered or densely sintered form.

Machining is usually carried out by material-removing processes and in particular by milling and/or grinding. It is particularly preferred that the machining is carried out in a CAD/CAM process. The starting glass according to the invention, the starting glass according to the invention with nuclei and the glass ceramic according to the invention with multiple quartz solid solution phases can be used for the machining. For this, the glasses and glass ceramics according to the invention can be used in particular in the form of blanks, e.g. powder compacts, for example in unsintered, partially sintered or densely sintered form.

After the dental restoration with desired shape has been produced, e.g. by pressing or machining, it can still be heat-treated to reduce the porosity, e.g. of a porous powder compact employed.

However, the glass ceramics according to the invention and the glasses according to the invention are also suitable as coating material of for example ceramics and glass ceramics. The invention is therefore likewise directed to the use of the glasses according to the invention or the glass ceramics according to the invention for coating, in particular of ceramics and glass ceramics.

The invention also relates to a process for coating ceramics, metals, metal alloys and glass ceramics, in which glass ceramic according to the invention or glass according to the invention is applied to the corresponding substrate and subjected to elevated temperature.

This can be done in particular by sintering on or by joining an overlay produced by CAD-CAM with a suitable glass solder or adhesive and preferably by pressing on. In the case of sintering on, the glass ceramic or glass is applied in the usual manner, e.g. as a powder, to the material to be coated, such as ceramic or glass ceramic, and then sintered at elevated temperature. In the preferred pressing-on, glass ceramic according to the invention or glass according to the invention, for example in the form of powder compacts, is pressed on at an elevated temperature, of for example 700 to 1200° C., and with the application of pressure, for example 2 to 10 bar. In particular, the processes described in EP 231 773 and the pressing furnace disclosed therein can be used for this purpose. A suitable furnace is, for example, the Programat EP 5000 from Ivoclar Vivadent AG, Liechtenstein.

Due to the above-described properties of the glass ceramics according to the invention and the glasses according to the invention, they are particularly suitable for use in dentistry. A further subject of the invention is therefore the use of the glass ceramics according to the invention or the glasses according to the invention as dental material, preferably for coating dental restorations and particularly preferably for producing dental restorations, such as bridges, inlays, onlays, veneers, abutments, partial crowns, crowns or facets.

The invention thus also relates to a process for producing a dental restoration, in particular a bridge, inlay, onlay, veneer, abutment, partial crown, crown or facet, in which the glass ceramic or glass according to the invention is given the shape of the desired dental restoration by pressing or by machining, in particular in a CAD/CAM process.

The invention is explained in more detail below by means of nonlimiting examples.

### EXAMPLES

### Examples 1 to 24—Composition and Crystal Phases

A total of 24 glasses and glass ceramics according to the invention with the composition indicated in Table I were produced by melting of corresponding starting glasses and subsequent heat treatment for controlled crystallization.

The heat treatments applied are also given in Table I. The following meanings apply

| | |
|---|---|
| T_{g} | Glass transition temperature, determined by DSC |
| T_{S} and t_{S} | Applied temperature and time for melting of the |
| | starting glass |
| T_{Kb} and t_{Kb} | Applied temperature and time for nucleation of |
| | the starting glass |
| T_{C} and t_{C} | Applied temperature and time for crystallization |
| T_{Sinter} and t_{Sinter} | Applied temperature and time for the sintering |
| T_{Press} and t_{Press} | Applied temperature and time for crystallization |
| | by hot pressing |
| CR value | Contrast value of glass ceramic determined |
| | according to British Standard BS 5612 using: |
| | Instrument: Spectrometer CM-3700d (Konica- |
| | Minolta) |
| | Measurement parameters: |
| | Measuring surface: 7 mm × 5 mm |
| | Measurement type: Remission/Reflection |
| | Measuring range: 400 nm-700 nm |
| | Sample size: |
| | Diameter: 15-20 mm |
| | Thickness: 2 mm +/− 0.025 mm |
| | Plane parallelism: +/−0.05 mm |
| | Surface roughness: about 18 μm. |
| CTE | Coefficient of thermal expansion of the glass |
| | ceramic according to ISO 6872 (2008), measured |
| | in the range from 100 to 500° C. |
| σ_{Biax} | Biaxial fracture strength, measured according to |
| | dental standard ISO 6872 (2008) |

For this purpose, the starting glasses were first melted from usual raw materials in a platinum-rhodium crucible at the temperature T_{S} for a duration t_{S} in air atmosphere.

In the examples 1 to 23 glass frits, i.e. glass granules, were produced by pouring the melted starting glasses into water. The glass frits were ground to a particle size of <45 μm using ball or mortar mills and pressed into powder compacts using powder presses.

The powder compacts were sintered, optionally after heat treatment at the temperature T_{Kb} for a duration t_{Kb} for nucleation, at temperature T_{Sinter} for a duration t_{Sinter} to dense bodies, during which nucleation and crystallization processes occurred simultaneously.

The sintered blanks thus obtained were optionally subsequently shaped by hot pressing at temperature T_{Press} for a duration t_{Press}.

In example 24 the melt of the starting glass was cast into a graphite mould to produced glass monoliths. These glass monoliths were directly after casting subjected to a first heat treatment at a temperature TK for a duration of t_{Kb} to form nuclei and then slowly cooled to room temperature. Subsequently they were subjected to a heat treatment at a temperature T_{C} for a duration of t_{C} to effect crystallisation.

In the following table I means:

TABLE I

| | Example | | | | |
|---|---|---|---|---|---|
| | 1 | 2 | 3 | 4 | 5 |
| Composition | Wt.-% | Wt.-% | Wt.-% | Wt.-% | Wt.-% |
| SiO₂ | 72.5 | 70.3 | 74.1 | 74.7 | 76.0 |
| Li₂O | 11.6 | 11.3 | 11.1 | 10.1 | 9.6 |
| K₂O | 1.7 | 1.7 | 1.7 | 1.8 | 1.7 |
| MgO | 4.4 | 4.3 | 2.9 | 3.6 | 2.8 |
| SrO | — | — | 2.8 | — | — |
| SnO | — | — | — | — | 0.1 |
| Al₂O₃ | 2.8 | 5.5 | 2.8 | 3.6 | 4.5 |
| Yb₂O₃ | — | — | — | 1.4 | — |
| Gd₂O₃ | — | — | — | — | 1.3 |
| Eu₂O₃ | — | — | — | — | 0.3 |
| ZrO₂ | — | — | 0.9 | — | — |
| GeO₂ | — | — | — | 1.0 | — |
| Ta₂O₅ | 3.2 | 3.1 | — | — | — |
| P₂O₅ | 3.8 | 3.8 | 3.7 | 3.8 | 3.7 |
| T_{g} [° C.] | 469 | | 457 | 461 | 471 |
| Tₛ [° C.] | 1500 | — | 1550 | 1550 | 1550 |
| tₛ [min] | 60 | — | 60 | 60 | 60 |
| T_{Sinter} [° C.] | 890 | 860 | 890 | 890 | 900 |
| t_{Sinter} [min] | 10 | 10 | 10 | 10 | 10 |
| Tₚᵣₑₛₛ [° C.] | — | 870 | — | — | — |
| tₚᵣₑₛₛ [min] | — | 25 | — | — | — |
| Crystal phases | Li₂Si₂O₅ | Li₂Si₂O₅ | Li₂Si₂O₅ | Li₂Si₂O₅ | Li₂Si₂O₅ |
| | Li₃PO₄ | Li₃PO₄ | Li₃PO₄ | Li₃PO₄ | Li₃PO₄ |
| | QMK1 | QMK1 | QMK1 | QMK1 | QMK1 |
| | QMK2 | QMK2:LAS | QMK2 | QMK2 | QMK2 |
| Strongest peak of QMK1 [°2Θ] | 26.0 | 25.9 | 26.0 | 26.0 | 26.0 |
| Strongest peak of QMK2 [°2Θ] | 26.5 | 26.3 | 26.5 | 26.4 | 26.4 |
| σ_{Biax} [MPa] | | | | | |
| CR value | | 71.25 | 46.16 | | |
| L* | | 90.81 | 92.08 | | |
| a* | | −0.11 | −0.72 | | |
| b* | | 6.22 | 5.82 | | |
| WAK_{100-500° C.} [10⁻⁶K⁻¹] | 12.89 | | | | 13.46 |

Example

| | 6 | 7 | 8 | 9 | 10 |
|---|---|---|---|---|---|
| Composition | Wt.-% | Wt.-% | Wt.-% | Wt.-% | Wt.-% |
| SiO₂ | 74.5 | 74.0 | 74.0 | 74.1 | 74.6 |
| Li₂O | 11.6 | 11.9 | 11.5 | 11.2 | 10.6 |
| K₂O | 1.9 | 1.7 | 1.7 | 1.7 | 1.7 |
| MgO | 3.3 | 4.5 | 3.6 | 3.5 | 3.5 |
| Al₂O₃ | 3.7 | 3.4 | 3.7 | 3.6 | 3.7 |
| B₂O₃ | — | — | — | — | 1.3 |
| Nd₂O₃ | — | — | — | 2.1 | — |
| Bi₂O₃ | — | — | 1.7 | — | — |
| Pr₂O₃ | — | 0.6 | — | — | — |
| CeO₂ | 0.1 | — | — | — | — |
| GeO₂ | 1.0 | — | — | — | — |
| MnO₂ | — | — | — | — | 0.8 |
| P₂O₅ | 3.8 | 3.9 | 3.8 | 3.8 | 3.8 |
| AgCl | 0.03 | — | — | — | — |
| AgBr | 0.03 | — | — | — | — |
| AgI | 0.04 | — | — | — | — |
| T_{g} [° C.] | 464 | 469 | 461 | 467 | 461 |
| Tₛ [° C.] | 1550 | 1550 | 1550 | 1550 | 1550 |
| tₛ [min] | 60 | 60 | 60 | 60 | 60 |
| T_{Sinter} [° C.] | 890 | 890 | 890 | 890 | 890 |
| t_{Sinter} [min] | 10 | 10 | 10 | 10 | 10 |
| Crystal phases | Li₂Si₂O₅ | Li₂Si₂O₅ | Li₂Si₂O₅ | Li₂Si₂O₅ | Li₂Si₂O₅ |
| | Li₃PO₄ | Li₃PO₄ | Li₃PO₄ | Li₃PO₄ | Li₃PO₄ |
| | QMK1 | QMK1 | QMK1 | QMK1 | QMK1 |
| | QMK2 | QMK2 | QMK2 | QMK2 | QMK2 |
| Strongest peak of QMK1 [°2Θ] | 26.0 | 26.0 | 26.0 | 26.0 | 26.0 |
| Strongest peak of QMK2 [°2Θ] | 26.4 | 26.4 | 26.5 | 26.4 | 26.4 |
| σ_{Biax} [MPa] | | | | | |
| CR value | | | | | |
| L* | | | | | |
| a* | | | | | |
| b* | | | | | |
| WAK_{100-500° C.} [10⁻⁶K⁻¹] | | | | | |

| | Example | | | | |
|---|---|---|---|---|---|
| | 11 | 12 | 13 | 14 | 15 |
| Composition | Wt.-% | Wt.-% | Wt.-% | Wt.-% | Wt.-% |
| SiO₂ | 72.5 | 78.7 | 77.3 | 71.7 | 71.7 |
| Li₂O | 11.6 | 8.7 | 7.7 | 10.2 | 12.7 |
| K₂O | — | 1.7 | 1.6 | 1.7 | 3.4 |
| Rb₂O | 3.3 | — | — | — | — |
| MgO | 3.6 | 2.8 | 2.8 | 2.8 | 3.7 |
| CaO | — | — | — | 2.0 | — |
| Al₂O₃ | 4.0 | 4.5 | 5.2 | 6.0 | 4.1 |
| La₂O₃ | 1.2 | — | — | — | — |
| Er₂O₃ | — | — | 2.6 | — | — |
| TiO₂ | — | 0.6 | — | — | — |
| CeO₂ | — | — | — | 1.2 | — |
| V₂O₅ | — | — | — | 0.3 | — |
| P₂O₅ | 3.8 | 3.0 | 2.8 | 4.1 | 4.4 |
| T_{g} [° C.] | 471 | 473 | 510 | 477 | 471 |
| Tₛ [° C.] | 1600 | 1600 | 1600 | 1600 | 1450 |
| tₛ [min] | 60 | 60 | 60 | 60 | 120 |
| T_{Sinter} [° C.] | 890 | 890 | 890 | 890 | 870 |
| t_{Sinter} [min] | 10 | 10 | 10 | 10 | 10 |
| Crystal phases | Li₂Si₂O₅ | Li₂Si₂O₅ | Li₂Si₂O₅ | Li₂Si₂O₅ | Li₂Si₂O₅ |
| | Li₃PO₄ | Li₃PO₄ | Li₃PO₄ | Li₃PO₄ | Li₃PO₄ |
| | QMK1 | QMK1 | QMK1 | QMK1 | QMK1 |
| | QMK2 | QMK2 | QMK2 | QMK2:LAS | QMK2 |
| Strongest peak of QMK1 [°2Θ] | 26.0 | 26.0 | 25.9 | 25.9 | 26.5 |
| Strongest peak of QMK2 [°2Θ] | 26.4 | 26.4 | 26.2 | 26.2 | 26.2 |
| σ_{Biax} [MPa] | | | | | 363 |
| CR value | 57.38 | 89.17 | 92.41 | | |
| L* | 92.06 | 94.81 | 91.13 | | |
| a* | −0.59 | −0.36 | 10.16 | | |
| b* | 6.05 | 2.5 | −2.15 | | |
| WAK_{100-500° C.} [10⁻⁶K⁻¹] | | | 13.76 | | |

Example

| | 16 | 17 | 18 | 19 | 20 |
|---|---|---|---|---|---|
| Composition | Wt.-% | Wt.-% | Wt.-% | Wt.-% | Wt.-% |
| SiO₂ | 73.4 | 73.2 | 77.2 | 74.3 | 73.5 |
| Li₂O | 11.8 | 10.7 | 10.6 | 11.9 | 11.8 |
| Na₂O | — | 1.7 | 1.5 | — | 0.4 |
| K₂O | 1.7 | — | — | 0.9 | — |
| Rb₂O | — | — | 4.0 | 1.7 | 2.6 |
| MgO | 2.9 | 3.0 | — | 3.6 | 3.3 |
| CaO | — | 1.0 | — | 0.3 | — |
| SrO | 3.7 | 1.0 | — | — | 0.9 |
| ZnO | — | — | — | 0.7 | — |
| Al₂O₃ | 2.7 | 4.6 | 2.8 | 2.8 | 3.7 |
| P₂O₅ | 3.8 | 3.8 | 3.9 | 3.8 | 3.8 |
| MoO₃ | — | 0.5 | — | — | — |
| WO₃ | — | 0.5 | — | — | — |
| T_{g} [° C.] | 457 | 468 | 458 | 458 | 463 |
| Tₛ [° C.] | 1500 | 1550 | 1550 | 1550 | 1550 |
| tₛ [min] | 60 | 60 | 60 | 60 | 60 |
| T_{Sinter} [° C.] | 900 | 890 | 890 | 890 | 890 |
| t_{Sinter} [min] | 30 | 10 | 10 | 10 | 10 |
| Crystal phases | Li₂Si₂O₅ | Li₂Si₂O₅ | Li₂Si₂O₅ | Li₂Si₂O₅ | Li₂Si₂O₅ |
| | Li₃PO₄ | Li₃PO₄ | Li₃PO₄ | Li₃PO₄ | Li₃PO₄ |
| | QMK1 | QMK1 | QMK1 | QMK1 | QMK1 |
| | QMK2 | QMK2 | QMK2 | QMK2 | QMK2 |
| Strongest peak of QMK1 [°2Θ] | 26.1 | 26.0 | 26.0 | 26.0 | 26.0 |
| Strongest peak of QMK2 [°2Θ] | 26.6 | 26.3 | 26.5 | 26.5 | 26.4 |
| σ_{Biax} [MPa] | | | | | |
| CR value | | | | | |
| L* | | | | | |
| a* | | | | | |
| b* | | | | | |
| WAK_{100-500° C.} [10⁻⁶K⁻¹] | | | | | |

| | Example | | | |
|---|---|---|---|---|
| | 21 | 22 | 23 | 24 |
| Composition | Wt.-% | Wt.-% | Wt.-% | Wt.-% |
| SiO₂ | 77.3 | 71.7 | 81.0 | 75.0 |
| Li₂O | 9.1 | 12.7 | 6.4 | 12.0 |
| Na₂O | 0.4 | — | — | — |
| K₂O | 0.5 | 3.4 | 1.7 | 1.7 |
| Rb₂O | 1.0 | — | — | — |
| MgO | 2.7 | 3.7 | 2.8 | 4.5 |
| SrO | — | — | — | — |
| ZnO | 0.7 | — | — | — |
| Al₂O₃ | 3.6 | 4.1 | 4.5 | 2.8 |
| ZrO₂ | 1.0 | — | — | — |
| TiO₂ | 0.7 | — | 0.6 | — |
| P₂O₅ | 3.0 | 4.4 | 3.0 | 4.0 |
| T_{g} [° C.] | 479 | 471 | 563 | 468 |
| Tₛ [° C.] | 1550 | 1450 | 1600 | 1550 |
| tₛ [min] | 60 | 120 | 120 | 60 |
| T_{Kb} [° C.] | — | 490 | — | 490 |
| t_{Kb} [min] | — | 10 | — | 20 |
| T_{C} [° C.] | | — | — | 900 |
| t_{C} [min] | — | — | — | 30 |
| T_{Sinter} [° C.] | 890 | 870 | 980 | — |
| t_{Sinter} [min] | 10 | 10 | 10 | — |
| Tₚᵣₑₛₛ [° C.] | — | 890 | — | — |
| tₚᵣₑₛₛ [min] | — | 25 | — | — |
| Crystal phases | Li₂Si₂O₅ | Li₂Si₂O₅ | QMK1 | QMK1 |
| | Li₃PO₄ | Li₃PO₄ | QMK2 | QMK2 |
| | QMK1 | QMK1 | Li₃PO₄ | Li₃PO₄ |
| | QMK2 | QMK2 | Li₂SiO₃ | Li₂Si₂O₅ |
| Strongest peak of QMK1 [°2Θ] | 25.9 | 26.5 | 26.1 | 26.0 |
| Strongest peak of QMK2 [°2Θ] | 26.4 | 26.2 | 26.5 | 26.5 |
| σ_{Biax} [MPa] | | | | |
| CR value | | 81.5 | | |
| L* | | 90.18 | | |
| a* | | 0.25 | | |
| b* | | 5.4 | | |
| WAK_{100-500° C.} [10⁻⁶K⁻¹] | | | | |

QMK: Quartz solid solution phase
QMK1: 1. quartz solid solution phase
QMK2: 2. quartz solid solution phase
LAS: Lithium aluminosilicate (Li₂O•Al₂O₃•7.5SiO₂)

The X-ray diffraction pattern resulting by X-ray diffraction of the glass ceramic obtained in Example 19 with CuKα radiation at room temperature is shown in FIG. 1. Below this X-ray diffraction pattern, the characteristic peaks (peak patterns) of the following crystal phases from the PDF-4+ 2020 database (International Centre for Diffraction Data) are reproduced and marked with the letters A to D:
A: Low quartz (α-SiO₂)
B: High quartz (β-SiO₂)
C: Lithium disilicate (Li₂Si₂O₅)
D: Lithium phosphate (Li₃PO₄)

In the X-ray diffraction pattern, two quartz solid solution phases are identifiable whose peak patterns are shifted toward smaller 2θ values compared to the peak pattern of low quartz and whose highest intensity peaks are at 26.5° 2θ and at 26.0° 2θ, respectively.

1. A glass ceramic, which comprises the following components

| Component | Wt.-% |
|---|---|
| SiO₂ | 68.0 to 81.0 |
| Li₂O | 6.0 to 14.0 |
| Al₂O₃ | 1.0 to 8.0 |

and comprises at least two different quartz solid solution phases.

2. The glass ceramic according to claim 1, which comprises at least one non-stoichiometric quartz solid solution phase(s).

3. The glass ceramic according to claim 1, which comprises at least one stoichiometric or non-stoichiometric aluminosilicate crystal phase(s).

4. The glass ceramic according to claim 1, which comprises at least two different quartz solid solution phases whose highest intensity reflection peaks in X-ray powder diffraction with Cu_{Kα} radiation are each in the range of 25 to 26.7° 2θ.

5. The glass ceramic according to claim 1, which comprises two different quartz solid solution phases whose highest-intensity reflection peaks in X-ray powder diffraction with Cu_{Kα} radiation have a spacing of at least 0.2° 2θ.

6. The glass ceramic according to claim 1, which comprises 70.0 to 79.0 wt.-% SiO₂.

7. The glass ceramic according to claim 1, which comprises 7.5 to 13.0 wt.-% Li₂O.

8. The glass ceramic according to claim 1, which comprises 2.0 to 6.5 wt.-% Al₂O₃.

9. The glass ceramic according to claim 1, which comprises 1.0 to 7.0 wt.-% P₂O₅.

10. The glass ceramic according to claim 1, which comprises 1.0 to 8.0 wt.-% oxide of monovalent elements Me^{I}₂O selected from the group of K₂O, Na₂O, Rb₂O, Cs₂O and mixtures thereof.

11. The glass ceramic according to claim 1, which comprises 0 to 5.0 wt.-% K₂O.

12. The glass ceramic according to claim 1, which comprises 0 to 9.0 wt.-% oxide of divalent elements Me^{II}O selected from the group of Cao, MgO, SrO, ZnO and mixtures thereof.

13. The glass ceramic according to claim 1, which comprises 0 to 6.0 wt.-% MgO.

14. The glass ceramic according to claim 1, which comprises 0 to 5.0 wt.-% oxide of trivalent elements Me^{III}₂O₃ selected from the group of B₂O₃, Y₂O₃, La₂O₃, Ga₂O₃, In₂O₃ and mixtures thereof.

15. The glass ceramic according to claim 1, which comprises SiO₂ and Li₂O in a molar ratio in the range of 2.2 to 6.0.

16. The glass ceramic according to claim 1, which comprises lithium disilicate or lithium metasilicate as main crystal phase.

17. The glass ceramic according to claim 1, which comprises at least 20 wt.-% lithium disilicate crystals.

18. The glass ceramic according to claim 1, which comprises 0.2 to 28 wt.-% quartz solid solution phases.

19. A starting glass comprising the components of the glass-ceramic according to claim 1.

20. The starting glass according to claim 19, which comprises nuclei for the crystallization of two different quartz solid solution phases and also nuclei for the crystallization of lithium disilicate or lithium metasilicate.

21. The glass ceramic according to claim 1, wherein the glass ceramic is in the form of a powder, a granulate, a blank or a dental restoration.

22. A process for producing the glass ceramic according to claim 1 in which a starting glass in particulate form is subjected to at least one heat treatment in the range from 800 to 1000° C.

23. (canceled)

24. (canceled)

25. A process of producing a dental restoration selected from a bridge, inlay, onlay, veneer, abutment, partial crown, crown or facet, in which the glass ceramic according to claim 1 is given the shape of the desired dental restoration by pressing or machining.
